(19) United States
(12) Patent Application Publication
(10) Pub. No.: US 2024/0199783 A1
(43) Pub. Date: Jun. 20, 2024

(54) CURABLE PRECURSOR OF AN ADHESIVE COMPOSITION

(71) Applicant: 3M INNOVATIVE PROPERTIES COMPANY, St. Paul, MN (US)

(72) Inventors: Ling Jie Tong, Shanghai (CN); Ahmad Shaaban, Koeln (DE); Adrian T. Jung, Kaarst (DE); Sascha Sprott, Essen (DE); Michael A. Kropp, Cottage Grove, MN (US); Binhong Lin, Woodbury, MN (US)

(21) Appl. No.: 18/553,853

(22) PCT Filed: May 21, 2021
(86) PCT No.: PCT/CN2021/095045

§ 371 Date: Oct. 4, 2023

(51) Int. Cl. C08F 222/14; C08F 212/14; C08K 3/22; C08K 5/14; C08K 5/18; C09J 11/04; C09J 11/06; C09J 125/18; C09J 133/06

(52) U.S. Cl. CPC C08F 222/14; C08F 212/26; C08K 3/22; C08K 5/14; C08K 5/18; C09J 11/04; C09J 11/06; C09J 125/18; C09J 133/062; C08K 2003/2227; C08K 2201/001

(57) ABSTRACT

The present disclosure relates to a curable precursor of an adhesive composition. the curable precursor comprising a first part and a second part, wherein the first part comprises: (a) a radically (co) polymerizable (meth) acrylate-based component comprising (i) C₁C₃₂ (meth) acrylic acid ester monomers; and wherein the second part comprises (b) an initiator; and (c) a vinyl aromatic compound. The present disclosure further relates to a process for making a cured composition from said curable precursor and to the use of said curable precursor for adhesive applications and/or for thermal management applications in the automotive industry.

### TECHNICAL FIELD

The present disclosure relates to a curable precursor of an adhesive composition comprising a radically (co)polymerizable (meth)acrylate-based component and a vinyl aromatic compound.

### BACKGROUND

Curable compositions have been known for years as suitable for use in a variety of applications that include general-use industrial applications such as adhesives and coatings, as well as high-performance applications in the electronics industry such as e.g. for sealing and bonding electronic components. With broadened use of curable compositions over the years, performance requirements have become more and more demanding with respect to, in particular, curing profile, adhesion performance, storage stability, handleability and processability characteristics, and compliance with environment and health requirements. When curable compositions are additionally required to provide thermal conductivity, the formulation of suitable compositions becomes even more challenging.

(Meth)acrylate structural adhesives are known to show outstanding mechanical properties and excellent overall bonding behavior. Examples of curable compositions provided with thermal conductivity are described in e.g. US 2007/0142528 A1 and EP 3 736 300 A1. A major draw back of these adhesives is the storage stability of their curable precursors, the so-called shelf life. If the very reactive initiating species which is required for initiating the polymerization reaction (“initiator”), and which may be a kind of thermo-labile peroxide, for example, is present in the same part of the composition that also contains the (meth)acrylate monomers, the shelf life of the composition will most likely be limited, and the curable precursors have to be cooled for storing or need to be stored in small containers of for example 50 or 200 mL. This is a result of the radicals that are released by the peroxide over time and which are initiating chain-extending reactions with the (meth)acrylate monomers that lead to increase in viscosity and finally even to unwanted solidification of the composition. The higher the reactivity, and the higher the amount of initiating species, the shorter the shelf life will be at a given temperature. High amounts of initiating species are needed for shorter open times of the adhesive.

Usually, the shelf-life of an acrylic structural adhesive can be improved by different methods.

For adhesive acrylic curable compositions where initiator and (meth)acrylate monomers are present in the same part of the curable precursor, the shelf life can be improved by storing the reactive monomers at very low temperatures, which will slow down the decomposition of the initiator and thereby delay the polymerization reaction. Another possibility is to store the reactive monomers in very small and preferably in air permeable packaging containers, which will suppress the formation of radicals by oxygen inhibition and help significantly to improve the overall shelf life. However, if the reactive monomers have to be stored in absence of air or in big drums with a volume of 100 or 200 liters and with limited air diffusion, the storage stability significantly decreases.

For adhesive acrylic curable compositions where the initiator can be kept apart from the (meth)acrylic monomers, the reactive initiator can be placed in a non-polymerizable carrier substance that does not contain reactive double-bonds and cannot contribute to the overall macroscopic adhesive performance. In this case the decomposition of the peroxide over storage time will not cause a solidification of the curable precursor as the released radicals do not initiate any kind of chain-extending reaction. However, the non-polymerizable carrier substance such as a non-reactive oligomer will behave as a plasticizer in the final product, as it does not directly react with the chemical network of the polymerization product. In some cases this can lead to migration of the carrier substance out of the cured composition with a direct influence on the aging behavior, as the migration of the carrier substance will change the material properties, particularly the mechanical properties, of the cured composition over time. Moreover, as the amount of the non-polymerizable carrier substance should be as low as possible, the resulting mixing ratio of the two parts of the curable precursor of the acrylic structural adhesive will be more challenging, with most systems ending up with a 10:1 mixing ratio which is unconvenient for use.

Examples for such non-polymerizable carrier substances typically used are benzoate esters such as dipropylene glycol dibenzoate, polytetrahydrofuran (poly THF), polyether, and polyethylene glycol (PEG).

There is still a need for a curable precursor of an adhesive acrylic composition having an improved storage stability, particularly a good storage stability at room temperature and a good storage stability in large containers of more than 10 L and up to 100 or 200 L, and being curable at room temperature.

As used herein, “a”, “an”, “the”, “at least one” and “one or more” are used interchangeably. The term “comprise” shall include also the terms “consist essentially of” and “consists of”.

### SUMMARY

In a first aspect, the present disclosure relates to a curable precursor of an adhesive composition, wherein the curable precursor comprises a first part and a second part, and wherein the first part comprises
(a) a radically (co)polymerizable (meth)acrylate-based component comprising
   (i) C₁-C₃₂ (meth)acrylic acid ester monomers; and wherein the second part comprises
(b) an initiator; and
(c) a vinyl aromatic compound.

In another aspect, the present disclosure also relates to a process for making a cured composition from the curable precursor as disclosed herein, the process comprising
providing a curable precursor, wherein the curable precursor comprises a first part
   and a second part, and wherein the first part comprises
      (a) a radically (co)polymerizable (meth)acrylate-based component comprising
         (i) C₁-C₃₂ (meth)acrylic acid ester monomers; and wherein the second part comprises
      (b) an initiator, and
      (c) a vinyl aromatic compound;
mixing the first and the second part of the curable precursor; and
curing the mixture of the first and the second part of the curable precursor.

In yet a further aspect, the present disclosure relates to the use of a curable precursor as disclosed herein, for adhesive applications and/or for thermal management applications in the automotive industry.

The curable precursor disclosed herein has a good storage stability and a low tendency for core polymerization during storage. The curable precursor disclosed herein may be stored in 100 or 200 Liter drums for several months at room temperature without the need for cooling. In some embodiments of the present disclosure, the curable precursor is a highly filled thermally conductive curable precursor, and even for these highly filled curable precursors with a low oxygen diffusion, the curable precursor has a good storage stability and a low tendency for core polymerization during storage.

Despite the curable precursor disclosed herein is stabilized for storage, a fast curing at room temperature is still possible. The performance of the cured product, i.e. properties such as hardness, overlap shear strength, elongation at break and thermal conductivity, is not adversely affected.

Surprisingly, it has been found that the initiator for polymerizing the (meth)acrylate-based component can be diluted by a vinyl aromatic compound in one part of the two-part curable composition without polymerization during storage, and that after the two parts of the curable composition have been mixed and curing has started, a fast curing at room temperature is possible. Furthermore, the vinyl aromatic compound takes part in the polymerization reaction of the (meth)acrylate-based component and does not have the function of a plasticizer which would negatively affect the aging behavior of the cured composition. In some embodiments, with the vinyl aromatic compound being a difunctional or multifunctional compound with two or more vinyl aromatic groups, the vinyl aromatic compound acts as a crosslinker for the (meth)acrylate based component and does not have the function of a plasticizer which would negatively affect the aging behavior of the cured composition. In some embodiments, with the vinyl aromatic compound being a monofunctional compound with only one vinyl aromatic group, the vinyl aromatic compound acts as a comonomer for the (meth)acrylate based component and does not have the function of a plasticizer which would negatively affect the aging behavior of the cured composition. The person skilled in the art would have expected that the vinyl aromatic compound, being able to copolymerize as a comonomer with the (meth)acrylate monomers, would also homopolymerize when combined with an initiator. It is surprising that the vinyl aromatic compound on the one hand does not homopolymerize and can therefore be used to dilute the initiator, and that on the other hand the vinyl aromatic compound copolymerizes with the (meth)acrylate monomers and therefore does not have the function of a plasticizer which would negatively affect the aging behavior of the cured composition.

Advantageously, the mixing ratio of the first and the second part of the curable precursor disclosed herein may be 4:1, whereas for curable precursors with the initiator being diluted with a plasticizer the mixing ratio of the first and the second part of the curable precursor would be around 10:1, which is not convenient for use. The mixing ratio of 10:1 for curable precursors with the initiator part being diluted by a plasticizer is required as the amount of plasticizer is intended to be as low as possible, as the plasticizer has a negative effect on the aging behavior of the cured composition. In the curable precursor disclosed herein, the initiator is mixed with the vinyl aromatic compound which does not act as a plasticizer, and therefore a more convenient mixing ratio such as 4:1 can be applied.

### DETAILED DESCRIPTION

Disclosed herein is a curable precursor of an adhesive composition, the curable precursor comprising a first part and a second part.

The first part of the curable precursor comprises
(a) a radically (co)polymerizable (meth)acrylate-based component comprising
   (i) C₁-C₃₂ (meth)acrylic acid ester monomers.

The second part of the curable precursor comprises
(b) an initiator, and
(c) a vinyl aromatic compound.

A “curable precursor” is meant to designate a composition which can be cured using an initiator. The term “initiator” is meant to refer to a substance or a group of substances able to start or initiate or contribute to the curing process of the curable precursor, i.e. to start or initiate or contribute to the radical (co)polymerization of the (meth)acrylate based component.

A “radically (co)polymerizable component” is meant to designate a composition which can be cured using an initiator containing or able to produce a free radical. A radically (co)polymerizable component may contain only one, two, three or more radically polymerizable groups. Typical examples of radically (co)polymerizable groups include unsaturated carbon groups, such as a vinyl group being present e.g in a (meth)acrylate group.

As used herein, “(meth)acryl” is a shorthand term referring to “acryl” and/or “methacryl”. For example, a “(meth)acrylate based component” refers to “acrylate based component” and/or “methacrylate based component”, and “C₁-C₃₂ (meth)acrylic acid ester monomers” refers to “C₁-C₃₂ acrylic acid ester monomers” and/or “C₁-C₃₂ methacrylic acid ester monomers”.

As used herein, “(co)polymerizable” is a shorthand term referring to “polymerizable” and/or “copolymerizable”.

A “monomer” is any chemical substance which can be characterized by a chemical formula, bearing radically polymerizable unsaturated groups (including (meth)acrylate groups) which can be polymerized to oligomers or polymers thereby increasing the molecular weight. The molecular weight of monomers can usually simply be calculated based on the chemical formula given.

The first and the second part of the curable precursor are the two parts of a two-part formulation of a curable precursor of an adhesive composition.

The first part of the curable precursor of an adhesive composition disclosed herein comprises (a) a radically (co)polymerizable (meth)acrylate-based component, i.e. a radically (co)polymerizable acrylate-based component or a radically (co)polymerizable methacrylate-based component or a combination thereof.

The radically (co)polymerizable (meth)acrylate-based component comprises (i) C₁-C₃₂ (meth)acrylic acid ester monomers, i.e. C₁-C₃₂ acrylic acid ester monomers, or C₁-C₃₂ methacrylic acid ester monomers, or a combination thereof. The C₁-C₃₂ (meth)acrylic acid ester monomers may be linear or branched C₁-C₃₂ (meth)acrylic acid ester monomers. Preferably, the radically (co)polymerizable (meth)acrylate-based component comprises C₁-C₃₂ acrylic acid ester monomers.

The initiator used herein contains or is able to produce a free radical. Exemplary initiators for use herein include, but are not limited to, organic peroxides. Organic peroxides include hydroperoxides, ketone peroxides and diacyl peroxides. Examples for hydroperoxides are cumene hydroperoxide, tert-pentyl hydroperoxide, diisopropylbenzene hydroperoxide, and 1,1,3,3-tetramethylbutyl hydroperoxide. An example for a ketone peroxide is methyl ethyl ketone peroxide.

An example for a diacyl peroxide is dibenzoyl peroxide. Examples for other organic peroxides are tert-butyl peroxybenzoate, dicumyl peroxide, 1,3-di-(2-tert-butylperoxyisopropyl)benzene, tert-butyl cumyl peroxide, and di-tert-butyl peroxide.

Preferably, dibenzoyl peroxide is used as initiator.

The curable precursor may comprise from 0.1 to 2 wt. %, or from 0.1 to 1 wt. % of the initiator, for example, based on the total weight of the curable precursor.

In some preferred embodiments of the present disclosure, the initiator is an organic peroxide, and the radically (co)polymerizable (meth)acrylate-based component comprises C₁-C₃₂ acrylic acid ester monomers. In other words, the radically (co)polymerizable (meth)acrylate-based component preferably comprises C₁-C₃₂ acrylic acid ester monomers, provided that the initiator is an organic peroxide.

In some embodiments of the present disclosure, the initiator is a hydroperoxide, and the radically (co)polymerizable (meth)acrylate-based component comprises C₁-C₃₂ methacrylic acid ester monomers, and the radically (co)polymerizable (meth)acrylate-based component does not comprise C₁-C₃₂ acrylic acid ester monomers.

In some embodiments of the present disclosure, the initiator is a hydroperoxide, and the radically (co)polymerizable (meth)acrylate-based component comprises C₁-C₃₂ methacrylic acid ester monomers, and the radically (co)polymerizable (meth)acrylate-based component comprises C₁-C₃₂ acrylic acid ester monomers.

The C₁-C₃₂ (meth)acrylic acid ester monomers for use in the radically (co)polymerizable (meth)acrylate-based component may be selected from the group consisting of iso-octyl (meth)acrylate, 2-ethylhexyl (meth)acrylate, 2-propylheptyl (meth)acrylate, butyl (meth)acrylate, cyclohexyl (meth)acrylate, methyl (meth)acrylate, benzyl (meth)acrylate, hydroxyethyl (meth)acrylate, hydroxypropyl (meth)acrylate, isobornyl (meth)acrylate, tetrahydrofurfuryl (meth)acrylate, and any mixtures thereof.

The C₁-C₃₂ (meth)acrylic acid ester monomers may have no functional groups.

The curable precursor may comprise from 1 to 50 wt. %, from 1 to 30 wt. %, from 1 to 20 wt. %, from 2 to 15 wt. %, or from 3 to 10 wt. % of the C₁-C₃₂ (meth)acrylic acid ester monomers, wherein the weight percentages are based on the total weight of the curable precursor.

The radically (co)polymerizable (meth)acrylate-based component of the first part of the curable precursor may further comprise
(ii) an ethylenically unsaturated acidic compound.

An “ethylenically unsatured acidic compound” is meant to include monomers, oligomers, and polymers having ethylenic unsaturation and acid and/or acid-precursor functionality.

Acidic-precursor functionalities include, e.g. anhydrides such as —CO—O—CO—, acid halides and pyrophosphates.

The acidic group preferably comprises one or more carboxylic acid residues, such as —COOH, phosphoric acid residues, such as —O—P(O)(OH)OH, phosphonic acid residues, or sulfonic acid residues, such as —SO₃H.

“Polymer” or “polymeric material” are used interchangeably to refer to a homopolymer, copolymer, terpolymer etc.

Specific examples of ethylenically unsaturated acidic compounds include, but are not limited to glycerol phosphate mono(meth)acrylates, glycerol phosphate di(meth)acrylates, hydroxyethyl (meth)acrylate phosphates, bis glycerol phosphate di(meth)acrylates, bis((meth)acryloxyethyl) phosphate, ((meth)acryloxypropyl) phosphate, bis((meth)acryloxypropyl) phosphate, bis((meth)acryloxy)propyloxy phosphate, (meth)acryloxyhexyl phosphate, bis((meth)acryloxyhexyl) phosphate, (meth)acryloxyoctyl phosphate, bis((meth)acryloxyoctyl) phosphate, (meth)acryloxydecyl phosphate, bis((meth)acryloxydecyl) phosphate, caprolactone methacrylate phosphate, di or tri(meth)acrylated citric acid, poly(meth)acrylated oligomaleic acid, poly(meth)acrylated polymaleic acid, poly(meth)acrylated poly(meth)acrylic acid, poly(meth)acrylated polycarboxyl-polyphosphonic acid, poly(meth)acrylated polychlorophosphoric acid, poly(meth)acrylated polysulfonate, poly (meth)acrylated polyboric acid, and the like.

The reaction products of (meth)acrylic acid with alkane diols (e.g. C₂ to C₂₀ or C₂ to C₁₂ or C₆ to C₁₀) and phosphorous oxide were found to be suitable as well.

Also monomers, oligomers, and polymers of unsaturated carboxylic acids such as (meth)acrylic acid, aromatic (meth)acrylated acids (e g., methacrylated trimellitic acids), and anhydrides thereof can be used. In some embodiments, acrylic acid or methacrylic acid is used as ethylenically unsaturated acidic compound (ii).

The curable precursor may comprise from 0.1 to 20 wt. %, from 0.1 to 10 wt. %, from 0.1 to 5 wt. %, from 0.1 to 3 wt. %, from 0.1 to 2 wt. %, from 0.2 to 2 wt. %, or from 0.2 to 1 wt. % of the ethylenically unsaturated acidic compound, wherein the weight percentages are based on the total weight of the curable precursor.

The curable precursor may comprise from 1 to 50 wt. %, from 1 to 30 wt. %, from 1 to 20 wt. %, or from 10 to 15 wt. % of the (meth)acrylate-based component, wherein the weight percentages are based on the total weight of the curable precursor.

The vinyl aromatic compound of the second part of the curable precursor disclosed herein is an organic compound according to general formula (1):

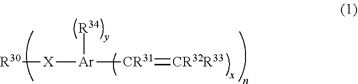

wherein
n is an integer having a value of 1 or greater;
x is an integer having a value of 1 or greater;
y is an integer having a value of 0 or greater;
Ar is a substituted aryl group;
R³¹ is selected from the group consisting of alkyl, aryl and halogen;
R³² and R³³ are independently selected from the group consisting of hydrogen, alkyl, aryl and halogen;
R³⁴ is an organic group wherein each R³⁴ is independently selected from the group consisting of alkyl, alkoxy, alkanoyl, alkanoyloxy, aryloxy, aroyl, aroyloxy, and halogen;
X is a divalent organic linking group or a covalent bond;
R³⁰ is an organic group;
wherein a total molecular weight of each X plus R³⁰ in said vinyl aromatic compound is 100 or greater.

In formula (1), n represents an integer having a value of 1 or greater, preferably 2 or greater. In formula (1), Ar represents a substituted aryl group, preferably having from 6-10 carbon atoms. Examples of Ar include a substituted benzene group having the formula C₆H_{5-x-y} or a substituted naphthalene group having the formula C₁₀H_{7-x-y}. Most preferably, Ar is a substituted benzene group.

In the vinyl aromatic compounds of formulas (1), the —CR³¹═CR³²R³³ group provides a site of unsaturation (i.e., a double bond) which is reactive with the radically (co)polymerizable (meth)acrylate-based component of the curable precursor. That is, the vinyl aromatic compound copolymerizes with the radically (co)polymerizable (meth)acrylate-based component and becomes chemically attached to the radically (co)polymerizable (meth)acrylate-based component. In formula (1), subscript x, which represents an integer having a value of 1 or greater, represents the number of unsaturated moieties bonded to each Ar group in the vinyl aromatic compound. Subscript x may be from 1 to 5. Preferably, x is equal to 1.

In formula (1), R³¹ is selected from the group consisting of alkyl, aryl and halogen. R³² and R³³ are independently selected from the group consisting of hydrogen, alkyl, aryl and halogen. Preferably, R³¹ is methyl and R³² and R³³ are hydrogen.

In formulas (1), R³⁴ represents a non-hydrogen substituent bonded to the aryl group Ar. Subscript y is an integer having a value of 0 or greater which represents the number of individual substituents bonded to the aryl group Ar. When y is equal to 1 or greater, each substituent R³⁴ may be independently selected from the group consisting of alkyl, alkoxy, alkanoyl, alkanoyloxy, aryloxy, aroyl, aroyloxy and halogen. Subscript y may be from 0 to 4. Preferably, y is equal to 0 in formula (1).

In formula (1), X represents either a divalent organic linking group or a covalent bond. Preferably, X is a divalent organic linking group comprising a urethane or a urea functional group. More preferably, X is:

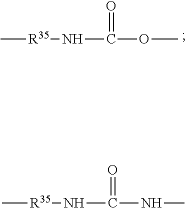

wherein R³⁵ and R³⁶ are divalent organic linking groups having from 1-10 carbon atoms. If present, R³⁵ and R³⁶ are bonded to the aryl group (Ar) of formula (1).

In formula (1), R³⁰ represents an organic group, preferably an oligomeric or polymeric organic group. The total molecular weight of each X plus R³⁰ is 100 or greater, more preferably 200 or greater, and most preferably 500 g/mol or greater. Representative examples of polymeric organic groups include hydrocarbon polymers (e.g., polyethylene, polystyrene, polypropylene, and polymethylpentene), carbon chain polymers (e.g., polyvinyl chloride, polyvinylidene chloride, and polyacrylonitrile), heterochain polymers (e.g., polyethers, polyamides, polyesters, polyurethanes, polysulfides, polysulfone, and polyimide). Suitable polymeric organic groups may be homopolymers or copolymers, for example, copolymers and terpolymers and may be alternating, random, block, or graft in structure. Typically, the total molecular weight of each X plus R³⁰ is from 100 to 20000 g/mol. Preferred organic groups R³⁰ include polyesters (e.g., polycaprolactone) having a molecular weight ranging from about 300-1000 g/mol and polyethers having a molecular weight ranging from about 500-3000 g/mol.

In formula (1), if n is 1, the vinyl aromatic compound is also referred to as a monofunctional vinyl aromatic compound. If n is 2, the vinyl aromatic compound is also referred to as a difunctional vinyl aromatic compound. If n is 3, the vinyl aromatic compound is also referred to as a trifunctional vinyl aromatic compound.

Preferred monofunctional vinyl aromatic compounds of formula (1) are represented below in general formula (1A) wherein, with reference to formula (1), Ar is a benzene ring, y is 0, R³¹ is methyl, R³² and R³³ are hydrogen, x is 1, and n is 1. The bonding structure to the benzene ring is shown generally and may be ortho, meta or para.

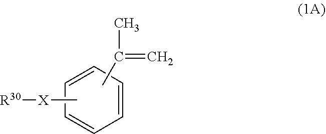

Representative examples of monofunctional vinyl aromatic compounds of formula (1A) include:

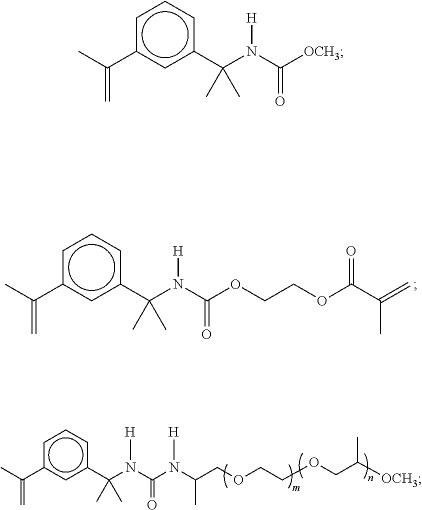

wherein m typically ranges from 0 to 50, and n typically ranges from 0 to 48.

In one embodiment, for example, m is equal to 6 and n is equal to 38.

Monofunctional vinyl aromatic compounds take part in the (co)polymerization reaction of the curable precursor and act as a comonomer for the (meth)acrylate based component in the curable precursor disclosed herein.

Preferred difunctional vinyl aromatic compounds of formula (1) are represented below in general formula (1B) wherein, with reference to formula (1), Ar is a benzene ring, y is 0, R³¹ is methyl, R³² and R³³ are hydrogen, x is 1, and n is 2. The bonding structure to the benzene rings is shown generally and may be independently on each ring ortho, meta or para.

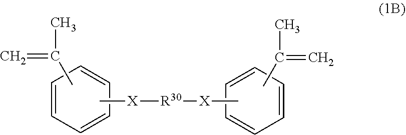

In formula (1B), X is a divalent organic group or a covalent bond as explained above for formula (1), R³⁰ is an organic group as explained above for formula (1). The total molecular weight of each X plus R³⁰ is 100 g/mol or greater, more preferably 200 g/mol or greater, and most preferably 500 g/mol or greater. Typically, the total molecular weight of each X plus R³⁰ is from 100 to 20000 g/mol.

Representative examples of the difunctional vinyl aromatic compounds of formula (1B) include:

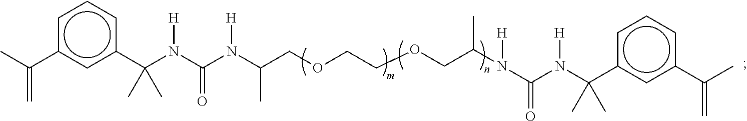

wherein n and m each is an integer and n and m each typically ranges from 0 to 50; and

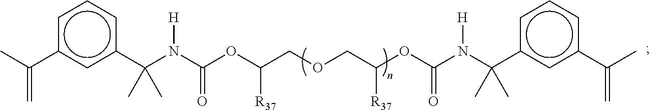

wherein n is an integer and typically ranges from 0 to 140, and R₃₇ is methyl or hydrogen.

These representative examples of the difunctional vinyl aromatic compounds of formula (1B) are a-methylstyrene functional polyether oligomers having urea linkages or urethane linkages.

Difunctional vinyl aromatic compounds take part in the (co)polymerization reaction of the curable precursor and act as a crosslinker for the (meth)acrylate based component in the curable precursor disclosed herein.

Preferred trifunctional vinyl aromatic compounds of formula (1) are represented below as general formula (1C) wherein, with reference to formula (1), Ar is a benzene ring, y is 0, R³¹ is methyl, R³² and R³³ are hydrogen, x is 1, and n is 3. The bonding structure to the benzene rings is shown generally and may be independently on each ring ortho, meta or para.

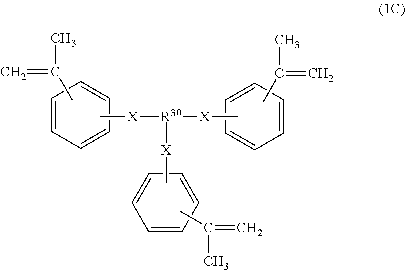

Representative examples of the trifunctional vinyl aromatic compounds of formula (1C) include:

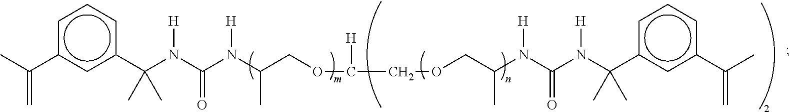

wherein (n+m) typically ranges from 5 to 85;

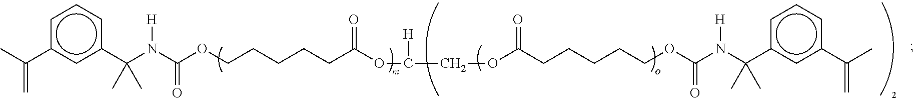

wherein (n+m) typically ranges from 2 to 18.

Trifunctional vinyl aromatic compounds take part in the (co)polymerization reaction of the curable precursor and act as a crosslinker for the (meth)acrylate based component in the curable precursor disclosed herein.

Also mixtures of monofunctional, difunctional and trifunctional vinyl aromatic compounds may be used for the adhesive precursor disclosed herein.

Useful vinyl aromatic compounds of general formula (1) may be prepared, for example, by reacting 3-isopropenyl-α,α-dimethylbenzyl isocyanate (commercially available under the trade designation “TMI” from Cytec Industries, West Peterson, NJ) with a mono- or multi-functional reactive hydrogen compound, preferably a mono- or multi-functional amine, alcohol or combination thereof. Particularly preferred mono- and multi-functional amines include the amine terminated polyethers commercially available under the trade designation “JEFFAMINE” (from Huntsman Chemical Co., Houston, TX, USA), for example “JEFFAMINE ED600” (a diamine terminated polyether having a reported molecular weight of 600), “JEFFAMINE D400” (a diamine terminated polyether having a reported molecular weight of 400), “JEFFAMINE D2000” (a diamine terminated polyether having a reported molecular weight of 2000), “JEFFAMINE T3000” (a tramine terminated polyether having a reported molecular weight of 3000), and “JEFFAMINE M2005” (a monoamine terminated polyether having a reported molecular weight of 2000). Suitable alcohol-containing compounds include, for example, polypropylene glycol, polycaprolactone triol, and diethylene glycol.

When the vinyl aromatic compound is synthesized as the reaction product of an alcohol with an isocyanate, it may be desirable to use a catalyst to speed the reaction between the isocyanate and the alcohol. Suitable catalysts are well known in the art and include, for example, dibutyltin dilaurate (DBTDL) (commercially available from Sigma-Aldrich, Germany).

The curable precursor may comprise from 1 to 50 wt. %, from 1 to 20 wt. %, from 2 to 30 wt. %, from 2 to 20 wt. %, or from 10 to 30 wt. % of the vinyl aromatic compound, wherein the weight percentages are based on the total weight of the curable precursor.

The first part of the curable precursor of the present disclosure may further comprise (d) a crosslinker for the (meth)acrylate-based component, which comprises at least one acid-functional group derived from phosphoric acid and at least one radically (co)polymerizable reactive group.

The crosslinker for the (meth)acrylate-based component comprises at least one acid-functional group derived from phosphoric acid. The crosslinker for the (meth)acrylate-based component may comprise at least two acid-functional group derived from phosphoric acid.

The at least one acid-functional group derived from phosphoric acid of the crosslinker may comprise at least one P—OH group.

The at least one acid-functional group derived from phosphoric acid of the crosslinker may be selected from the group consisting of monoesters of phosphoric acid, diesters of phosphoric acid, triesters of phosphoric acid, esters of diphosphoric acid, diesters of diphosphoric acid, and any combinations or mixtures thereof.

The at least one acid-functional group derived from phosphoric acid of the crosslinker may be selected from the group consisting of monoesters of phosphoric acid and C₁-C₆ polyol derivatives, diesters of phosphoric acid and C₁-C₆ polyol derivatives, triesters of phosphoric acid and C₁-C₆ polyol derivatives, esters of diphosphoric acid and C₁-C₆ polyol derivatives, diesters of diphosphoric acid and C₁-C₆ polyol derivatives, and any combinations or mixtures thereof.

According to one preferred aspect of the disclosure, the at least one acid-functional group derived from phosphoric acid of the crosslinker is selected from the group consisting of monoesters of phosphoric acid and derivatives of 1,3-isomer of glycerol, diesters of phosphoric acid and derivatives of 1,3-isomer of glycerol, diesters of diphosphoric acid and derivatives of 1,3-isomer of glycerol, and any combinations or mixtures thereof.

According to another preferred aspect of the disclosure, the at least one acid-functional group derived from phosphoric acid of the crosslinker is selected from the group consisting of monoesters of phosphoric acid and derivatives of 1,2-isomer of glycerol, diesters of phosphoric acid and derivatives of 1,2-isomer of glycerol, diesters of diphosphoric acid and derivatives of 1,2-isomer of glycerol, and any combinations or mixtures thereof.

The crosslinker for the (meth)acrylate-based component comprises at least one radically (co)polymerizable reactive group.

The crosslinker for the (meth)acrylate-based component may comprise at least two radically (co)polymerizable reactive groups.

In a preferred aspect of the disclosure, the crosslinker comprises at least one radically (co)polymerizable reactive group selected from the group consisting of ethylenically unsaturated groups.

In a more preferred aspect of the disclosure, the ethylenically unsaturated groups comprised in the crosslinker are selected from the group consisting of (meth)acrylic groups, vinyl groups, styryl groups, and any combinations or mixtures thereof. More preferably, the ethylenically unsaturated groups are selected from the group consisting of methacrylic groups, acrylic groups, and any combinations or mixtures thereof.

In a particularly preferred aspect of the disclosure, the ethylenically unsaturated groups comprised in the crosslinker are selected from the group of methacrylic groups.

Advantageously, the crosslinker for use herein is an ethylenically unsaturated compound.

According to a particularly preferred aspect, the crosslinker for use in the present disclosure comprises the reaction product(s) of the reaction of phosphoric acid with either 1,3-glycerol dimethacrylate or 1,2-glycerol dimethacrylate.

According to another particularly preferred aspect, the crosslinker for use in the present disclosure is selected from the group consisting of 1,3-glycerol dimethacrylate phosphate monoester, 1,2-glycerol dimethacrylate phosphate monoester, 1,3-glycerol dimethacrylate phosphate diester, 1,2-glycerol dimethacrylate phosphate diester, 1,3-glycerol dimethacrylate diphosphate diester, 1,2-glycerol dimethacrylate diphosphate diester, and any mixtures thereof.

In an advantageous aspect of the present disclosure, the crosslinker for the (meth)acrylate-based component is (co)polymerizable with monomer units (i) and/or (ii) of the (meth)acrylate-based component.

In some embodiments, the crosslinker (b) may further have the function of an adhesion promoter.

The curable precursor of the present disclosure may comprise from 0.01 to 10 wt. %, from 0.01 to 8 wt. %, from 0.05 to 6 wt. %, from 0.05 to 5 wt. %, from 0.05 to 4 wt. %, from 0.1 to 2 wt. %, or even from 0.1 to 1 wt. %, of the crosslinker for the (meth)acrylate-based component, wherein the weight percentages are based on the total weight of the curable precursor.

The first part of the curable precursor disclosed herein may further comprise
(e) a polyether oligomer having a number average molecular weight of at least 2000 g/mol and which comprises at least one radically (co)polymerizable reactive group.

Unless otherwise indicated, the number average molecular weight of the polyether oligomer for use herein is determined by conventional gel permeation chromatography (GPC) using appropriate techniques well known to those skilled in the art.

Without wishing to be bound by theory, it is believed that the polyether oligomer as described above acts as a reactive diluent and rheological modifier for the curable precursor, which contributes to provide the curable precursor with outstanding flexibility characteristics. The polyether oligomer is also believed to beneficially impact the adhesion properties of the curable precursor, due in particular to the beneficial surface wetting properties provided in particular by the oligomeric polyether moiety. For curable precursors comprising thermally conductive particles, the polyether oligomer as described above is also believed to provide advantageous surface interactions with the thermally conductive particles, which in turn contribute to enable relatively high loading of thermally conductive particles due in particular to the improved compatibility provided between the thermally conductive particles and the surrounding (meth)acrylate-based polymeric matrix. Further, the polyether oligomer for use herein is also believed to beneficially impact the shear strength, due in particular to the light crosslinking effect provided by the radically (co)polymerizable reactive group(s), and to provide aging stability and hydrolytic stability.

The polyether oligomer having a number average molecular weight of at least 2000 g/mol and which comprises at least one radically (co)polymerizable reactive group may comprise a (linear) polyether backbone. The polyether oligomer backbone comprised in the polyether oligomer may be obtained by copolymerization of tetrahydrofuran units, ethylene oxide units, and optionally propylene oxide units. The molar ratio of these monomers may be in a range from 1:2.5 to 1:5, or even from 1:3 to 1:4.

The polyether oligomer for use herein may have a number average molecular weight more than 2000 g/mol, more than 2500 g/mol, more than 3000 g/mol, more than 3500 g/mol, or even more than 4000 g/mol.

The polyether oligomer for use herein may have a number average molecular weight of at most 20.000 g/mol, at most 15.000 g/mol, at most 12.000 g/mol, at most 10.000 g/mol, at most 9500 g/mol, at most 9000 g/mol, at most 8500 g/mol, or even at most 8000 g/mol.

The polyether oligomer for use herein may have a number average molecular weight in a range from 2000 to 20.000 g/mol, from 2000 to 15.000 g/mol, from 2000 to 12.000 g/mol, from 2500 to 10.000 g/mol, from 2500 to 9.000 g/mol, from 3000 to 8500 g/mol, from 3500 to 8000 g/mol or even from 4000 to 8000 g/mol.

In an advantageous aspect, the polyether oligomer for use in the present disclosure comprises at least two radically (co)polymerizable reactive groups.

According to another advantageous aspect, the at least one radically (co)polymerizable reactive group of the polyether oligomer is selected from the group consisting of ethylenically unsaturated groups. In other words, the polyether oligomer for use herein may be an ethylenically unsaturated compound.

In a more advantageous aspect of the disclosure, the ethylenically unsaturated groups comprised in the polyether oligomer are selected from the group consisting of (meth)acrylic groups, vinyl groups, styryl groups, and any combinations or mixtures thereof. More preferably, the ethylenically unsaturated groups are selected from the group consisting of methacrylic groups, acrylic groups, and any combinations or mixtures thereof.

In a particularly preferred aspect of the disclosure, the ethylenically unsaturated groups comprised in the polyether oligomer are methacrylic groups.

According to one advantageous aspect of the curable precursor of the disclosure, the polyether oligomer for use herein has the following formula:

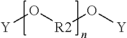

wherein:
Y is a radically (co)polymerizable reactive group, in particular an ethylenically unsaturated group; each R2 is independently selected from the group consisting of alkylene groups having in particular from 2 to 6 carbons;
and n is an integer selected such that the number average molecular weight of the polyether oligomer is of at least 2000 g/mol.

In one particular aspect, n is selected such that the number average molecular weight is at least 2000 g/mol, at least 3000 g/mol, or even at least 4000 g/mol. In another particular aspect, n is selected such that the number average molecular weight is at most 20.000 g/mol, at most 15.000 g/mol, or even at most 10.000 g/mol. In still another particular aspect, n is selected such that the number average molecular weight is between 2000 and 20.000 g/mol, between 3000 and 15.000 g/mol, or even between 3000 and 10.000 g/mol, where all ranges are inclusive of the end points.

The curable precursor of the present disclosure may comprise from 1 to 50 wt. %, from 1 to 30 wt. %, from 1 to 20 wt. %, from 2 to 15 wt. %, or from 3 to 10 wt. % of the polyether oligomer, wherein the weight percentages are based on the total weight of the curable precursor.

The polyether oligomer is (co)polymerizable with the C₁-C₃₂ (meth)acrylic acid ester monomers (i) and the optional ethylenically unsaturated acidic compound (ii) of the (meth)acrylate-based component (a).

The radically (co)polymerizable (meth)acrylate-based component (a) of the curable precursor disclosed herein may further comprise
(iii) ethylenically unsaturated monomers having a functional group and which are copolymerizable with the C₁-C₃₂ (meth)acrylic acid ester monomers (i) and the optional ethylenically unsaturated acidic compound (ii) of the radically polymerizable (meth)acrylate-based component (a).

Without wishing to be bound by theory, it is believed that the presence of ethylenically unsaturated monomers having a functional group in the (meth)acrylate-based component beneficially impacts its shear strength and adhesion properties. The ethylenically unsaturated monomers having a functional group are further believed to provide advantageous surface interactions with the thermally conductive particles, which in turn contribute to provide advantageous rheological profile to the curable precursor of the present disclosure.

The ethylenically unsaturated monomers having a functional group and for use herein may have a functional group selected from the group consisting of amine, hydroxyl, amide, isocyanate, epoxide, nitrile, and any combinations thereof.

The ethylenically unsaturated monomers having a functional group may be selected from the group consisting of methoxyethyl (meth)acrylate, ethoxyethyl (meth)acrylate, 2-hydroxyethyl (meth)acrylate, 2-aminoethyl (meth)acry late, dimethylaminoethyl (meth)acrylate, diethylaminoethyl (meth)acrylate, N-vinyl pyrrolidone, N-vinyl caprolactam, (meth)acrylamide, N-vinylacetamide, 4-acryloyl morpholine, glycidyl (meth)acrylate, 2-isocyanato ethyl (meth)acrylate, tert-butylamino ethyl (meth)acrylate, acrylonitrile, and any mixtures thereof.

The radically (co)polymerizable (meth)acrylate-based component (a) of the curable precursor disclosed herein may comprise from 1 to 15 wt. %, from 2 to 12 wt. %, from 3 to 10 wt. %, from 4 to 10 wt. %, or even from 5 to 10 wt. %, of the ethylenically unsaturated monomers having a functional group, wherein the weight percentages are based on the total weight of the (meth)acrylate-based component.

The first part of the curable precursor disclosed herein may further comprise
(f) an accelerator for radically (co)polymerizing the curable precursor.

The accelerator may be a base.

As used herein, by “base”, it is meant an Arrhenius base. Further, by “base”, it is meant a substance that, when dissolved in an aqueous solution, increases the concentration of hydroxide (OH) ions in the solution.

The base may be a tertiary amine, or a combination of tertiary amines.

The tertiary amine has the formula R¹R²R³-N, where R¹, R² and R³ are independently alkyl groups or aryl groups. Suitable tertiary amine bases include, but are not limited to, p-toluidine ethoxylate (synonymous with N,N-bis(2-hydroxyethyl)-p-toluidine), N,N-dimethyl-p-toluidine, N,N-dimethylaniline, N,N-diethylaniline, and diisopropyl p-toluidine.

The accelerator may also be sulfinic acid; an azo compound such as azoisobutyric acid dinitrile; an alpha-aminosulfone such as bis(tolylsulfonmethyl)-benzyl amine; propane sulfonyl chloride; para-toluene sulfonyl chloride; and an aldehyde-amine condensation product, for example the condensation product of an aliphatic aldehyde such as butyraldehyde with a primary amine such as aniline or butylamine.

The accelerator may also be an Fe(II)-salt such as Fe(II)-sulfate.

The curable precursor may comprise from 0.1 to 5 wt. %, or from 0.1 to 3 wt. %, of the accelerator, for example, based on the total weight of the curable precursor.

The curable precursor disclosed herein may further comprise
(g) thermally conductive particles.

The thermally conductive particles are used as a filler for the curable precursor to improve thermal conductivity of the cured composition.

The thermally conductive particles may be comprised in the first part or in the second part of the curable precursor. The thermally conductive particles may also be comprised in the first and the second part of the curable precursor.

The thermally conductive particles for use herein may be selected from the group consisting of metal oxides, metal nitrides, metal hydroxides, metallic particles, coated metallic particles, ceramic particles, coated ceramic particles, and any combinations or mixtures thereof.

Preferably, the thermally conductive particles are selected from the group consisting of aluminum oxide, aluminum hydroxide, boron nitride, aluminum nitride, silicon nitride, gallium nitride, silicon oxide, magnesium oxide, zinc oxide, zirconium oxide, tin oxide, copper oxide, chromium oxide, titanium oxide, silicon carbide, graphite, magnesium hydroxide, calcium hydroxide, carbon nanotubes, carbon black, carbon fibers, diamond, clay, aluminosilicate, calcium carbonate, barium titanate, potassium titanate, copper, silver, gold, nickel, aluminum, platinum, and any combinations or mixtures thereof.

More preferably, the thermally conductive particles are selected from the group consisting of aluminum oxide, aluminum hydroxide, boron nitride, and any combinations or mixtures thereof.

Even more preferably, the thermally conductive particles are selected from the group consisting of aluminum oxide, aluminum hydroxide, and any combinations or mixtures thereof.

The thermally conductive particles may comprise primary particles, agglomerates of primary particles, or combinations thereof.

The thermally conductive primary particles and agglomerates of primary particles may have isotropic shapes, anisotropic shapes, or combinations thereof.

The thermally conductive primary particles and agglomerates of primary particles may have spherical shapes, platelet shapes, or combinations thereof.

Exemplary thermally conductive primary particles and agglomerates of primary particles for use herein are described e.g. in EP 3 127 973 A1 (Wieneke et al.).

The mean particle size (d₅₀) of the thermally conductive primary particles and agglomerates of primary particles may be from 0.2 to 500 μm, or from 0.2 to 100 μm. The mean particle size (d₅₀) of the thermally conductive primary particles and agglomerates of primary particles can be measured by laser diffraction.

Through-plane thermal conductivity may become most critical in some applications, such as e.g. thermally-conductive filler applications. For these applications, isotropic thermally conductive particles (e.g., spherical particles) may be preferred, as asymmetrical fibers, flakes, or platelets may tend to align in the in-plane direction.

The thermally conductive particles may comprise thermally conductive particles provided with a surface functionalization. The surface functionalization of the thermally conductive particles may have a polarity selected from the group consisting of acidic-functional, basic-functional, hydrophobic, hydrophilic, and any combinations or mixtures thereof.

In one advantageous aspect of the disclosure, the surface functionalization of the thermally conductive particles comprises hydrophobic surface functionalization.

In the context of the present disclosure, the expression “hydrophobic surface functionalization” is meant to express that the surface of the thermally conductive particles, after suitable surface modification, has little or no affinity for polar substances, in particular water. The expression “hydrophilic surface functionalization” is meant to express that the surface of the thermally conductive particles, after suitable surface modification, has relatively high affinity for polar substances, in particular water.

The thermally conductive particles may be further provided with flame-retardancy properties or/and electrical insulation properties.

The curable precursor disclosed herein may comprise from 5 to 95 wt. %, from 30 to 90 wt. %, from 30 to 80 wt. %, from 40 to 90 wt. %, from 40 to 80 wt. %, from 50 to 90 wt. %, from 50 to 80 wt. %, from 60 to 90 wt. %, or from 65 to 85 wt. % of the thermally conductive particles, wherein the weight percentages are based on the total weight of the curable precursor.

The curable precursor may further comprise additives such as dispersing agents, antioxidants, flame retardants, or dyes.

According to another advantageous aspect of the disclosure, the curable precursor is (substantially) free of solvent(s), in particular organic solvent(s).

The curable precursor of the present disclosure is in the form of a two-part composition having a first part and a second part, wherein the first part and the second part are kept separated prior to combining the two parts and forming the cured composition.

The first part comprises the radically (co)polymerizable (meth)acrylate-based component comprising the C₁-C₃₂ (meth)acrylic acid ester monomers. The second part comprises the initiator for radical polymerization and the vinyl aromatic compound. For the second part, homopolymerisation of the vinyl aromatic compound does not occur, and the second part can be stored in e.g. 100-200 1 drums for several weeks or months. Curing can be started by combining the first part and the second part of the curable precursor disclosed herein, and a fast curing, even at room temperature, is possible despite the stabilization of the second part.

In an advantageous aspect of the disclosure, the two parts of the curable precursor may be mixed with a mixing ratio of the first part to the second part in a range from 10:1 to 1:1, or from 5:1 to 3:1. Preferably, the two parts of the curable precursor may be mixed with a mixing ratio of the first part to the second part of 4:1.

Further disclosed herein is also a process for making a cured composition from the curable precursor disclosed herein, the process comprising
providing a curable precursor, wherein the curable precursor comprises a first part and a second part, and wherein the first part comprises
   (a) a radically (co)polymerizable (meth)acrylate-based component comprising
      (i) C₁-C₃₂ (meth)acrylic acid ester monomers; and wherein the second part comprises
   (b) an initiator; and
   (c) a vinyl aromatic compound;
mixing the first and the second part of the curable precursor; and curing the mixture of the first and the second part of the curable precursor.

All the particular and preferred aspects relating to, in particular, the (meth)acrylate-based component, the initiator and the vinyl aromatic compound which were described hereinabove in the context of the curable precursor, are fully applicable to the method as described above.

The first and the second part of the curable precursor can be extruded from a 2K cartridge or a 2K system using a static or dynamic mixer.

As used herein, “hardening” or “curing” a composition or mixture are used interchangeably and refer to (co)polymerization and/or crosslinking reactions including chemical (co)polymerization techniques (e. g., chemical reactions forming radicals effective to (co)polymerize radically (co)polymerizable compounds such as ethylenically unsaturated compounds) involving one or more materials included in the composition.

The curable precursor disclosed herein is curable without using any actinic radiation, in particular UV light.

The curable precursor disclosed herein is curable without using any additional thermal energy.

The curable precursor disclosed herein is curable without the need for expensive catalysts such as platinum.

Despite the stabilization of the initiator of the curable precursor, by the vinyl aromatic compound of the present disclosure, curing can be carried out very fast at room temperature, without the need of UV light or increased temperatures.

The cured composition made by the process disclosed herein may be in the form of an adhesive gap filler.

In the context of the present disclosure, the expression “adhesive gap filler” is meant to designate an adhesive composition that is used to at least partially fill a spatial gap between a first and a second surface. After mixing the first and the second part of the curable precursor, the curable precursor can flow into the spatial gap between a first and a second surface and fill it, and after curing of the curable precursor the cured composition provides an adhesive bond between the first and the second surface with good mechanical properties and good adhesive strength. The first surface may be a battery cell of an electric vehicle, and the second surface may be a cooling plate.

The adhesive gap filler may be a thermally conductive adhesive gap filler, by addition of thermally conductive particles.

Curing may be carried out at a temperature below 50° C., or at a temperature of at most 40° C., or at most 30° C., or at room temperature (23° C.). Preferably, curing is carried out at room temperature (23° C.).

Typically, curing is carried out for at most 1 hour. Curing may be carried out for at most 45 minutes, or for at most 30 minutes. Typically, after a curing time of 30 minutes at room temperature (23° C.), a cured composition having an adhesive strength of at least 0.7 MPa is obtained. The adhesive strength of the cured composition after a curing time of 30 minutes at room temperature (23° C.) may be at least 1 MPa, or at least 2 MPa, or at least 3 MPa, depending on the amount of initiator that has been used.

According to an advantageous aspect, the curable precursor of the disclosure is curable at 23° C. at a curing percentage greater than 90%, greater than 95%, greater than 98%, or even greater than 99%, after a curing time no greater than 72 hours, no greater than 48 hours, or even no greater than 24 hours, depending on the amount of initiator that has been used.

The curing time may be adjusted as desired depending on the targeted applications and manufacturing requirements.

The cured composition made by the process disclosed herein may have a thermal conductivity of at least 0.1 W/mK, at least 0.3 W/mK, at least 0.5 W/mK, at least 0.7 W/mK, at least 1.0 W/mK, at least 1.2 W/mK, or at least 1.5 W/mK, when measured according to the test method described in the experimental section.

The cured composition made by the process disclosed herein may have an overlap shear strength (OLS) of at least 0.5 MPa, at least 2.0 MPa, at least 2.5 MPa, at least 3.0 MPa, at least 3.5 MPa, at least 4.0 MPa, or at least 4.5 MPa, when measured according to the test method described in the experimental section.

The cured composition made by the process disclosed herein may have an overlap shear strength (OLS) in a range from 0.5 to 30.0 MPa, from 2.0 to 8.0 MPa, from 2.5 to 8.0 MPa, from 2.5 to 7.0 MPa, from 3.0 to 7.0 MPa, from 3.5 to 6.5 MPa, or from 4.0 to 6.0 MPa, when measured according to the test method described in the experimental section.

The cured composition may have an elongation at break of at least 5%, at least 8%, or at least 10%, when measured according to the test method described in the experimental section.

The curable precursor disclosed herein and the cured composition made from the curable precursor may be used for adhesive applications and/or for thermal management applications in the automotive industry.

The curable precursor and the cured composition as described above may be used for the manufacturing of a battery module comprising a plurality of battery cells, in particular for use in the automotive industry.

For embodiments of the curable precursor which comprise thermally conductive particles, the curable precursor and the cured composition may be used as thermally conductive adhesive for battery applications.

### EXAMPLES

### Test Methods

### Preparation of the Formulations for Testing:

The samples for testing the mechanical and thermal behavior are prepared from a 4:1 (vol ratio) mixture of two components (Part A: Part B) extruded from a 2K cartridge using a static mixer (standard 3M gold Quadro nozzle for 50 mL cartridges or SULZER MF 10-18 nozzles for 200 mL cartridges). The preparation of both parts is described hereinafter. Within the open time, the obtained paste is applied to the surface of the test panel as a 2 mm film. The surface of test samples (25 mm*100 mm*4 mm) for the overlap shear strength test (aluminum, grade EN AW2024T3) are sandblasted before bonding using pure corundum with a grain size of about 135 micrometers. The test samples are left at ambient room temperature (23° C.+/−2° C., 50% relative humidity+/−5%) for 7 days. The various performance testing are measured as described below.

### 1. Thermal Conductivity Test

The thermal conductivity of the cured compositions is measured according to ASTM E1461 at 23° C. with Laser Flash Analysis (LFA) using Light Flash Apparatus LFA 467 HyperFlash®, commercially available from Netzsch GmbH, Germany, on samples having a thickness of 2 mm.

### 2. Overlap Shear Strength (OLS) According to DIN EN 1465

Overlap shear strength is determined according to DIN EN 1465 using a Zwick Z050 tensile tester (commercially available by Zwick GmbH & Co. KG, Ulm, Germany) operating at a cross head speed of 10 mm/min. For the preparation of an overlap shear strength test assembly, the paste resulting from the mixing of Part A and Part B is spackled onto one surface of a test panel. The aluminum EN AW2024T3 test panels are sandblasted before bonding. Afterwards, the sample is covered by a second aluminum strip forming an overlap joint of 13 mm. Hereby, the use of glass beads having a selected diameter distribution ensured formation of a bond line having a thickness of about 300 micrometers. The overlap joints are then clamped together using two binder clips and the test assemblies are further stored at room temperature for 7 days after bonding, and then placed into an air circulating oven for 30 minutes at 80° C. The samples are either tested directly at room temperature or undergo aging and are tested thereafter. Five samples are measured for each of the examples and results averaged and reported in MPa.

### 3. Tensile Measurements According to DIN EN ISO 527-2-5A

Tensile measurements (tensile strength, elongation at break and elastic modulus) are carried out according to DIN ISO 527-2-5A using a Zwick Z050 tensile tester (commercially available by Zwick GmbH & Co. KG, Ulm, Germany) operating at a cross head speed of 10 mm/min. Films having a thickness of about 2 mm are prepared according to the procedure described above. Five samples having a dog bone shape are stamped according to the geometry of DIN ISO 527-2-5A (dimensions 25 mm×4 mm×2 mm) and used for further mechanical testing. Measurements are done for each of the samples and the results are averaged and reported in MPa for the tensile strength and in percentage for the elongation at break.

### 4. Viscosity Measurements

Viscosity of the test samples is measured at 20° C. with an Anton Paar rheometer MCR 302 using RheoCompass software from Anton Paar. The measurements were done using a frequency sweep at shear rates from 0.1 to 5 s⁻¹. 90 measurement points were taken one every 2 s at 0.1 s⁻¹, 20 measurement points were taken one every 2 s at 0.5 s⁻¹, 20 measurement points were taken one every 1 s at 1.0 s⁻¹, and 40 measurement points were taken one every 0.5 s at 5 s⁻¹.

### Raw Materials

In the examples, the following raw materials are used.

2-Ethylhexylacrylate (2-EHA) is an acrylic acid ester monomer obtained from BASF AG, Germany.

Cyclohexyl methacrylate (CHMA) is an acrylic acid ester monomer obtained from BASF AG, Germany.

Acrylic acid (AA) is a monomer obtained from BASF AG, Germany.

Alpha methyl styryl polyurea resin (AMSPU) is an a-methylstyrene functional polyether oligomer having urea linkage. The a-methylstyrene functional oligomer having urea linkage was prepared as follows: 120 g (0.6 moles) of 3-isopropenyl-α,α-dimethylbenzyl isocyanate (commercially available as TMI from Cytec Industries, West Peterson, NJ, USA) and 600 g (0.6 amine equivalents) of amine-terminated polyether (D2000, difunctional amine-terminated polyether, commercially available as Jeffamine™ D2000 from Huntsman Chemical Co., Houston, TX, USA, nominal reported MW 2000) were combined with stirring at room temperature in a glass vessel and allowed to stand at room temperature overnight. Infrared spectroscopy (IR) indicated complete reaction by disappearance of the 2265 cm-1 isocyanate band. The calculated molecular weight of the α-methylstyrene functional oligomer is 2460 g/mol.

Peroxan BP-Paste 50 PF-1 is dibenzoyl peroxide, an initiator for polymerization, which is obtained from Pergan GmbH, Germany.

Diol-6000-DMA is a dimethacrylate polyether oligomer having a number average molecular weight of about 6000 g/mol, and which is obtained from 3M Espe GmbH, Germany.

GLP is a dimethacrylate crosslinker derived from phosphoric acid, and which is obtained from 3M Espe GmbH, Germany.

Martoxid™ 2320 is an aluminum oxide-based thermally conductive filler, which is obtained from Martinswerk, Germany.

BAK70 is a spherical aluminum oxide-based thermally conductive filler, which is obtained from Bestry, China.

B53 is an aluminum hydroxide-based flame retardant and thermally conductive filler, which is obtained from Nikkeikin, Japan.

Martinal™ 2550 is an aluminum hydroxide-based thermally conductive and flame retardant filler, which is obtained from Martinswerk, Germany

BF083 is an aluminum hydroxide-based thermally conductive and flame retardant filler, which is obtained from Nikkeikin, Japan.

Apyral 200SM is an aluminum hydroxide-based thermally conductive and flame retardant filler, which is obtained from Nabaltec, Germany.

Martinal™ 2590 is an aluminum hydroxide-based thermally conductive and flame retardant filler, which is obtained from Martinswerk, Germany

Martinal ON908 is an aluminum hydroxide-based thermally conductive and flame retardant filler, which is obtained from Martinswerk, Germany

Pergaquick A150 PM is p-toluidine ethoxylate, a base, which is obtained from Pergan GmbH, Germany.

Disperse BYK 145 is a dispersing agent, which is obtained from BYK, Germany.

BYK-W 9010 is a dispersing agent, which is obtained from BYK-Chemie GmbH, Germany. DISPERBYK-145 is a dispersing agent, which is obtained from BYK-Chemie GmbH, Germany.

Irganox 1076 is an antioxidant, which is obtained from BASF, Germany.

Irgafos 168 is an antioxidant, which is obtained from BASF, Germany.

4-Methoxyphenol (MEHQ) is an inhibitor, which is obtained from Sigma-Aldrich, Germany.

Irgazin Red L 3670 HD is a red pigment, which is obtained from BASF AG, Germany.

4-hydroxy-2,2,6,6-tetramethylpiperidine-1-oxyl (4-OH-TEMPO, TEMPOL) is a nitroxide obtained from Evonik Industries AG, Germany.

Benzoflex 9-88 is a plasticizer based on dipropylene glycol dibenzoate, available from Eastman Chemical Company, Kingsport, TN, USA.

### Example 1 (EX1) and Comparative Examples 1 and 2 (CEX1 and CEX2)

For Comparative Example 1, 10 g of AMSPU (vinyl aromatic compound), 0.2 g of Peroxan BP-Paste 50 PF-1 (initiator), and 0.2 g of Pergaquick A150 PM (accelerator) were mixed in a 100 mL speed mixer cup (speed mixer DAV 150FV, available from Hauschild Engineering, Germany) stirring at 3500 rpm for 90 seconds until a homogeneous mixture is achieved. The mixture was heated up to 50° C. for 1 hour. No curing could be observed, showing that AMSPU did not homopolymerize.

For Comparative Example 2, 10 g of 2-EHA (acrylic acid ester monomer), 0.2 g of Peroxan BP-Paste 50 PF-1 (initiator), and 0.2 g of Pergaquick A150 PM (accelerator) were mixed in a 100 mL speed mixer cup (speed mixer DAV 150FV, available from Hauschild Engineering, Germany) stirring at 3500 rpm for 90 seconds until a homogeneous mixture is achieved. The mixture was heated up to 50° C. After less than 30 minutes, a low viscosity polymer was obtained, showing that homopolymerization of 2-EHA has occurred.

For Example 1, 5 g of 2-EHA (acrylic acid ester monomer), 5 g of AMSPU (vinyl aromatic compound), 0.2 g of Peroxan BP-Paste 50 PF-1 (initiator), and 0.2 g of Pergaquick A150 PM (accelerator) were mixed in a 100 mL speed mixer cup (speed mixer DAV 150FV, available from Hauschild Engineering, Germany) stirring at 3500 rpm for 90 seconds until a homogeneous mixture is achieved. The mixture was kept at room temperature (23° C.). After less than 15 minutes, a solid elastic reaction product is obtained showing that copolymerization of 2-EHA and AMSPU has occurred.

### Examples 2 to 5 (EX2 to EX5)

With Examples 2 to 5, the stability of the second part of curable precursors as disclosed herein regarding core polymerization was tested. For Examples 2 to 5, the second part of a curable precursor as disclosed herein having the formulations as shown in Table 1 was prepared. The formulations in Table 1 represent the second part (also referred to as “Part B”) of a two-part formulation of a curable precursor.

For Examples 2 to 5, AMSPU was used as vinyl aromatic compound, which is an a-methylstyrene functional oligomer with polyurea linkage according to formula

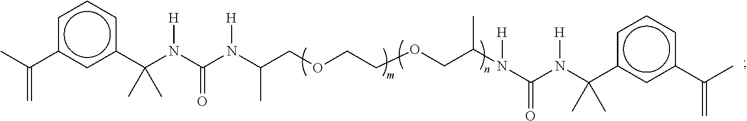

where n and m each ranges from 0 to 50. AMSPU was prepared as described above.

For Example 2, the second part of the curable precursor is prepared by combining the ingredients from the list of materials of Table 1 in a 100 mL speed mixer cup (speed mixer DAV 150FV, available from Hauschild Engineering, Germany) stirring at 3500 rpm for 90 seconds until a homogeneous mixture is achieved. The material is then slightly degassed to avoid entrapped air.

The alpha methylstyryl polyurea resin and the various thermally conductive particles are added first, followed by the peroxide and other additives in successive steps one by one. During the mixing, the temperature of the mixing shall not exceed 40° C. For Example 2, 100 g of the second part of the curable precursor (Part B) were prepared.

For Examples 3 and 4, the second part of the curable precursor is prepared by combining the ingredients from the list of materials of Table 1 in a 10 L butterfly mixer and mixing for 60 minutes until a homogeneous mixture is achieved. The alpha methylstyryl polyurea resin and the various thermally conductive particles are added first, followed by the peroxide and other additives in successive steps one by one. During the mixing, the temperature of the mixing shall not exceed 40° C. For Examples 3 and 4, 5 kg of the second part of the curable precursor (Part B) were prepared.

Example 5 is manufactured in industrial scale. The second part of the curable precursor is prepared by combining the ingredients from the list of materials of Table 1 in a butterfly mixer and mixing for 60 minutes until a homogeneous mixture is achieved. The alpha methylstyryl polyurea resin and the various thermally conductive particles are added first, followed by the peroxide and other additives in successive steps one by one. During the mixing, the temperature of the mixing shall not exceed 40° C. For Example 4, 1000 kg of the second part of the curable precursor (Part B) were prepared and stored in 100 L drums.

The second part of the curable precursor of Examples 2 to 5 is in the form of a paste.

In Table 1, all concentrations are given as wt. %.

TABLE 1

| | EX2 | EX3 | EX4 | | EX5 |
|---|---|---|---|---|---|
| | EX6 | EX7 | EX8 | CEX3 | EX9 |
| | Part B | Part B | Part B | Part B | Part B |
| Raw material | [wt %] | [wt %] | [wt %] | [wt %] | [wt %] |
| AMSPU | 17.82 | 18.00 | 21.71 | — | 17.86 |
| Benzoflex 9-88 | — | — | — | 21.71 | — |
| Peroxan BP-Paste 50 | 1.62 | 1.71 | 2.00 | 2.00 | 1.69 |
| PF-1 | | | | | |
| Martoxid TM2320 | 38.88 | 40.13 | — | — | 40.21 |
| BAK 70 | 13.89 | — | — | — | — |
| B53 | 27.76 | 40.13 | 41.47 | 41.47 | 40.21 |
| Martinal TM 2550 | — | — | 34.56 | 34.56 | — |
| Irganox 1076 | 0.02 | 0.02 | 0.02 | 0.02 | 0.02 |
| Irgazin Red L 3670 HD | 0.01 | 0.01 | 0.01 | 0.01 | 0.01 |
| 4-OH-TEMPO | — | — | 0.02 | 0.02 | — |
| Water dest. | — | — | 0.20 | 0.20 | — |

The stability of the second part of the curable precursors regarding core polymerization was tested using glass containers, as glass containers have a limited oxygen diffusion. Before filling the glass containers, the curable precursor material was degassed in a Speedmixer for 1:30 min under vacuum (−900 mbar). The glass containers were fully filled with material (52.5 g material in a 25 ml glass container), and care has been taken that no air bubbles are in the material to ensure a low oxygen atmosphere. This experimental setup is a simulation of the situation in the middle of a drum having a volume of 100-200 Liter fully filled with material. For each of the formulations, three glass containers were filled.

The filled glass containers were stored at 50° C. for accelerated aging of the test samples.

No core polymerization was noticed for Examples 2 to 5 even after more than one month at 50° C.

For Example 5, after storage of the second part of the curable precursor in drums of 100 L at room temperature (23° C.) for 6 months, no core polymerization has been observed.

### Examples 6 to 9 (EX6 to EX9) and Comparative Example 3 (CEX3)

For Examples 6 to 9, the second part (Part B) of a curable precursor as disclosed herein was prepared as described above for Examples 2 to 5, with the compositions as shown in Table 1. For Comparative Example 3, the second part (Part B) of a curable precursor was prepared as described above for Examples 2 to 5, with the composition as shown in Table 1.

For Example 6, the first part of the curable precursor (also referred to as “Part A”) is prepared by combining the ingredients from the list of materials of Table 2 in a 100 mL speed mixer cup (speed mixer DAV 150FV, available from Hauschild Engineering, Germany) stirring at 3500 rpm for 90 seconds until a homogeneous mixture is achieved. The material is then slightly degassed to avoid entrapped air. The acrylic acid ester monomers, the ethylenically unsaturated acidic compound (acrylic acid) and the crosslinker are added first, followed by the polyether oligomer, the various thermally conductive particles and other additives in successive steps. During the mixing, the temperature of the mixing shall not exceed 40° C.

For Example 6, 100 g of the first part of the curable precursor (Part A) and 100 g of the second part of the curable precursor (Part B) were prepared.

For Examples 7 and 8, and for Comparative Example 3, the first part (Part A) of the curable precursor is prepared by combining the ingredients from the list of materials of Table 2 in a 10 L butterfly mixer and mixing for 120 minutes until a homogeneous mixture is achieved. The acrylic acid ester monomers, the ethylenically unsaturated acidic compound (acrylic acid) and the crosslinker are added first, followed by the polyether oligomer, the various thermally conductive particles and other additives in successive steps. During the mixing, the temperature of the mixing shall not exceed 40° C.

The composition of the first part of the curable precursor (Part A) of Comparative Example 3 corresponds to the composition of the first part of the curable precursor (Part A) of Example 8. For the second part of the curable precursor (Part B) of Comparative Example 3, AMSPU was replaced by Benzoflex 9-88.

For Examples 7 and 8, 5 kg of the first part of the curable precursor (Part A) and 5 kg of the second part of the curable precursor (Part B) were prepared. For Comparative Example 3, 100 g of the first part of the curable precursor (Part A) as prepared for Example 8 were used, and 100 g of the second part (Part B) were prepared as described above.

For Example 9, the first part (Part A) of the curable precursor is prepared by combining the ingredients from the list of materials of Table 2 in an industrial scale mixer (butterfly mixer) and mixing for 120 minutes until a homogeneous mixture is achieved. The acrylic acid ester monomers, the ethylenically unsaturated acidic compound (acrylic acid) and the crosslinker are added first, followed by the polyether oligomer, the various thermally conductive particles and other additives in successive steps. During the mixing, the temperature of the mixing shall not exceed 40° C.

For Example 9, 1000 kg of the first part of the curable precursor (Part A) and 1000 kg of the second part of the curable precursor (Part B) were prepared.

The first part and the second part of the curable precursors of Examples 6 to 9 and Comparative Example 3 are in the form of a paste.

In Tables 1 and 2, all concentrations are given as wt. %.

TABLE 2

| | | | EX8 | |
|---|---|---|---|---|
| | EX6 | EX7 | CEX3 | EX9 |
| | Part A | Part A | Part A | Part A |
| Raw material | [wt %] | [wt %] | [wt %] | [wt %] |
| 2-EHA | 8.25 | 8.50 | 9.61 | 8.70 |
| CHMA | — | — | 1.49 | — |
| AA | 0.50 | 0.50 | 0.74 | 0.50 |
| Diol-6000-DMA | 9.01 | 8.70 | 9.61 | 8.77 |
| GLP | 0.75 | 0.75 | 0.87 | 0.65 |
| Martoxid TM2320 | 38.07 | 38.07 | — | 38.00 |
| B53 | 12.52 | 12.50 | 11.95 | 12.50 |
| Apyral 200SM | 7.01 | 7.10 | 4.96 | 7.00 |
| BF083 | 23.34 | 23.33 | — | 23.3 |
| Martinal TM 2550 | — | — | 15.87 | — |
| Martinal TM 2590 | — | — | 12.62 | — |
| Martinal ON908 | — | — | 31.795 | — |
| Pergaquick A150 PM | 0.42 | 0.42 | 0.47 | 0.42 |
| Irganox 1076 | 0.02 | 0.02 | 0.01 | 0.01 |
| Disperse BYK 145 | 0.10 | 0.10 | — | — |
| BYK-W 9010 | — | — | — | 0.10 |
| MEHQ | 0.005 | 0.01 | — | 0.001 |
| Irgafos 168 | — | — | — | 0.05 |
| 4-OH-TEMPO | — | — | 0.005 | 0.003 |

After having prepared separately the first and the second part of the curable precursor, the two parts are filled in a Part A: Part B=4:1 volume ratio into a 2K cartridge and the mixture is applied to the surface of the test panel as described above, to generate films and samples for testing mechanical and thermal properties using a room temperature curing step.

Overlap shear samples, dog-bone shape samples for elongation at break and tensile strength and samples for thermal conductivity measurements are cured for 24 hours (Examples 6 to 9) or seven days (Examples 8 and 9, and Comparative Example 3) at room temperature or ten days at 40° C. and 100% humidity (Examples 8 and 9, and Comparative Example 3). Measurements are carried out as described above in the Test Methods Section.

Test results are shown in Table 3 (for Examples 6 and 7), Table 4 (for Example 8 and Comparative Example 3), and Table 5 (for Example 9). Table 3 shows the results after 24 hours curing at room temperature (23° C.). For Examples 8 and 9 and Comparative Example 3, the test for 10 days at 40° C. and 100% humidity was carried out according to DIN EN ISO 6270. The curing test for 10 days at 40° C. and 100% humidity is a test for accelerated aging of the cured adhesives.

The resulting cured compositions of the curable precursors as disclosed herein have good mechanical properties and good thermal conductivity.

TABLE 3

| | EX6 | EX7 |
|---|---|---|
| Thermal conductivity [W/mK] | 1.5 | 1.5 |
| Overlap shear strength [MPa] | 5.1 | 4.9 |
| Tensile strength [MPa] | 4.9 | 4.9 |
| Elongation at break [%] | 12.1 | 9.4 |

TABLE 4

| | EX8 | EX8 | EX8 | EX8 | CEX3 | CEX3 |
|---|---|---|---|---|---|---|
| Curing conditions | 30 min, | 24 h, | 7 d, | 10 d, 40° C. | 7 d, | 10 d, 40° C. |
| | 23° C. | 23° C. | 23° C. | (100% humidity) | 23° C. | (100% humidity) |
| Thermal | — | 1.6 | — | 1.5 | — | — |
| conductivity | | | | | | |
| [W/mK] | | | | | | |
| Overlap shear | 1.5 | 4.9 | 5.5 | 5.2 | 4.4 | 3.6 |
| strength [MPa] | | | | | | |
| Tensile strength | — | 4.8 | 4.9 | 4.8 | 4.1 | 3.5 |
| [MPa] | | | | | | |
| Elongation at | — | 12.3 | 12.1 | 10.4 | 22.5 | 18.5 |
| break [%] | | | | | | |
| Elastic modulus | — | 123 | 95 | 140 | 26 | 49 |
| [MPa] | | | | | | |

As can be seen from Table 4, the adhesive strength (overlap shear strength) after 7 days curing at room temperature (23° C.) of Comparative Example 3, with the plasticizer in the second part of the curable precursor, is about 20% lower than the adhesive strength (overlap shear strength) after 7 days curing at room temperature (23° C.) of Example 8, with the vinyl aromatic compound in the second part of the curable precursor.

The tensile strength after 7 days curing at room temperature (23° C.) of Comparative Example 3 is about 16% lower than the tensile strength after 7 days curing at room temperature (23° C.) of Example 8.

For Example 8, after 10 days curing at 40° C. and 100% humidity, the adhesive strength (overlap shear strength) has decreased only slightly by about 5.5% compared to 7 days curing at 23° C. For Comparative Example 3, after 10 days curing at 40° C. and 100% humidity, the adhesive strength (overlap shear strength) has decreased significantly by about 18% compared to 7 days curing at 23° C.

For Example 8, after 10 days curing at 40° C. and 100% humidity, the tensile strength has decreased only slightly by about 2% compared to 7 days curing at 23° C. For Comparative Example 3, after 10 days curing at 40° C. and 100% humidity, the tensile strength has decreased significantly by about 15% compared to 7 days curing at 23° C.

The adhesive strength (overlap shear strength) after 10 days curing at 40° C. and 100% humidity of Comparative Example 3, with the plasticizer in the second part of the curable precursor, is about 30% lower than the adhesive strength (overlap shear strength) after 10 days curing at 40° C. and 100% humidity of Example 8, with the vinyl aromatic compound in the second part of the curable precursor.

These results show that the aging behavior of a cured adhesive made from a curable precursor as disclosed herein (Example 8) is improved compared to a cured adhesive made from a curable precursor using a plasticizer to dilute the initiator (Comparative Example 3). This can be explained as the plasticizer is not participating in the chemical network of the final polymer and might migrate out of the cured composition over time, or might decompose or hydrolyze, and thereby is impairing the adhesive and mechanical properties of the cured composition, whereas the vinyl aromatic compound does not migrate out of the cured composition and is instead able to co-polymerize with the acrylic monomers and to contribute to the overall performance of the cured composition.

TABLE 5

| | EX9 | EX9 | EX9 | EX9 |
|---|---|---|---|---|
| Curing conditions | 30 min, | 24 h, | 7 d, | 10 d, 40° C. |
| | 23° C. | 23° C. | 23° C. | (100% |
| | | | | humidity) |
| Thermal conductivity [W/mK] | — | 1.5 | 1.5 | — |
| Overlap shear strength [MPa] | 0.9 | 4.3 | 4.5 | 3.8 |
| Elongation at break [%] | — | 9.0 | 10.0 | 7.6 |

For Example 9, the stability of the second part (Part B) of the curable precursor regarding core polymerization was tested using glass containers, as described above, with the difference that larger glass containers filled with 1 kg of material were used.

The filled glass containers were stored at 80° C. for accelerated aging of the test samples.

No core polymerization was noticed for Part B of Example 9 even after three days at 80° C.

The reactivity of the second part of the curable precursor with the first part of the curable precursor was tested after storage of the second part for 24 h and 48 h at 50° C. After storage of the second part for 24 h and 48 h at 50° C. (1 kg of material in glass container), the second part was mixed with the first part of the curable precursor in a ratio of 4:1 (mixing ratio first part:second part). Rheological measurements were carried out to determine the gel point (reactivity of the initiator).

For Example 9, oscillating rheology was measured to determine the curing kinetic. The gel point (i.e. the point where storage and loss modulus become equivalent) is at less than 30 minutes after the two parts of the two-part formulation have been combined. This shows that the curing at room temperature is fast.

For Example 9, after storage of the second part of the curable precursor in drums of 100 L at room temperature (23° C.) for 3 months, and after mixing the second part with the first part of the curable precursor of Example 9 (mixing ratio first part:second part=4:1) after 3 months storage, the gel point of the curable precursor still was at less than 30 minutes. This shows that even after 3 months storage, the curing at room temperature is fast.

1. A curable precursor of an adhesive composition, wherein the curable precursor comprises a first part and a second part, and wherein the first part comprises
(a) a radically (co)polymerizable (meth)acrylate-based component comprising
(i) C₁-C₃₂ acrylic acid ester monomers; and wherein the second part comprises
(b) an initiator that is an organic peroxide; and
(c) a vinyl aromatic compound.

2. (canceled)

3. (canceled)

4. The curable precursor of claim 1, wherein the C₁-C₃₂ acrylic acid ester monomers are selected from the group consisting of iso-octyl acrylate, 2-ethylhexyl acrylate, 2-propylheptyl acrylate, butyl acrylate, cyclohexyl acrylate, methyl acrylate, benzyl acrylate, hydroxyethyl acrylate, hydroxypropyl acrylate, isobornyl acrylate, tetrahydrofurfuryl acrylate, and any mixtures thereof.

5. The curable precursor of claim 1, wherein the radically (co)polymerizable (meth)acrylate-based component further comprises
(ii) an ethylenically unsaturated acidic compound.

6. The curable precursor of claim 1, wherein the vinyl aromatic compound is according general formula (1) 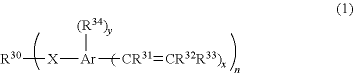
wherein
n is an integer having a value of 1 or greater;
x is an integer having a value of 1 or greater;
y is an integer having a value of 0 or greater;
Ar is a substituted aryl group;
R³¹, R³² and R³³ are independently selected from the group consisting of hydrogen, alkyl, aryl and halogen;
R³⁴ is an organic group wherein each R³⁴ is independently selected from the group consisting of alkyl, alkoxy, alkanoyl, alkanoyloxy, aryloxy, aroyl, aroyloxy, and halogen;
X is a divalent organic linking group or a covalent bond;
R³⁰ is an organic group;
wherein a total molecular weight of each X plus R³⁰ in said vinyl aromatic compound is 100 or greater.

7. The curable precursor of claim 6, wherein the vinyl aromatic compound of formula (1) has the formula 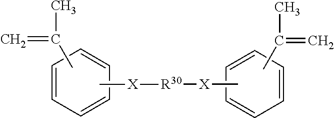
wherein
X is a divalent organic group or a covalent bond;
R³⁰ is an organic group;
wherein a total molecular weight of each X plus R³⁰ is 100 or greater.

8. The curable precursor of claim 7, wherein the vinyl aromatic compound of formula (1) is a difunctional vinyl aromatic compound selected from the group consisting of: 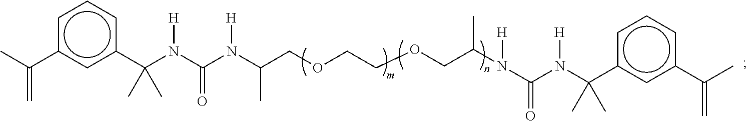
wherein n and m each is an integer and n and m each range from 0 to 50; and 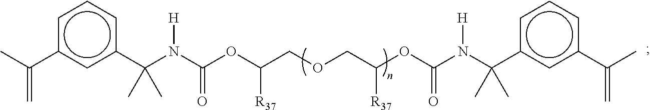
wherein n ranges from 0 to 140, and R₃₇ is methyl or hydrogen.

9. The curable precursor of claim 1, wherein the first part of the curable precursor further comprises
(d) a crosslinker for the (meth)acrylate-based component, which comprises at least one acid-functional group derived from phosphoric acid and at least one radically (co)polymerizable reactive group.

10. The curable precursor of claim 1, further comprising
(e) a polyether oligomer having a number average molecular weight of at least 2000 g/mol and which comprises at least one radically (co)polymerizable reactive group.

11. The curable precursor of claim 1, further comprising
(f) an accelerator for radically (co)polymerizing the curable precursor.

12. The curable precursor of claim 1, further comprising
(g) a thermally conductive particles.

13. A process for making a cured composition from the curable precursor of claim 1, the process comprising
providing a curable precursor, wherein the curable precursor comprises a first part and a second part, and wherein the first part comprises
(a) a radically (co)polymerizable (meth)acrylate-based component comprising
(i) C₁-C₃₂ (meth)acrylic acid ester monomers; and wherein the second part comprises
(b) an initiator that is an organic peroxide; and
(c) a vinyl aromatic compound;
mixing the first and the second part of the curable precursor; and
curing the mixture of the first and the second part of the curable precursor.

14. The process of claim 13, wherein curing is carried out at a temperature below 50° C.

15. Use of a curable precursor according to claim 1, for adhesive applications and/or for thermal management applications in the automotive industry.
